(19) United States
(12) Patent Application Publication
(10) Pub. No.: US 2005/0100035 A1
(43) Pub. Date: May 12, 2005

(54) Adaptive source routing and packet processing

(75) Inventors: Derek Chiou, Nashua, NH (US); Larry R. Dennison, Westwood, MA (US); William J. Dally, Stanford, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avici Systems, Inc., N. Billerica, MA (US)

(21) Appl. No.: 10/815,458

(22) Filed: Apr. 1, 2004

Related U.S. Application Data
(60) Provisional application No. 60/518,946, filed on Nov. 11, 2003.

(51) Int. Cl. H04L 12/28; H04L 12/56

(52) U.S. Cl. 370/412; 370/395.4; 370/389

(57) ABSTRACT

Paths for packets traveling through a distributed network fabric are chosen using information local to the source of packets. The system allows resequencing of packets at their destination and detecting out-of-order and missing packets.

### RELATED APPLICATION

This application claims the benefit of U.S. Provisional Application No. 60/518,946, filed on Nov. 11, 2003. The entire teachings of the above application are incorporated herein by reference.

### BACKGROUND OF THE INVENTION

A generalized communication system comprises a set of input ports and a set of output ports. Data enters the system through the input ports and is forwarded to zero or more of the output ports. The system passes data from the input ports to the output ports through an intermediate interconnection network, or fabric.

Network routers and parallel computers are two examples of communication systems that use an interconnection network.

Network routers are employed on computer networks. A popular type of computer network is the so-called Internet Protocol (IP) based network, i.e., networks conforming to Request for Comments (RFC) 0791 distributed by the Internet Engineering Task Force (IETF). IETF maintains, develops, and distributes a variety of network standards commonly referred to by their numbers as RFCs. A global IP network comprising a large number of interconnected local networks is known as the Internet. A full set of RFCs is available at the IETF's Internet site.

An IP network is a packet-switched network. A packet consists of binary data. It is sent from one network device to another network device usually through several intermediate network devices, known as routers, that determine to which network device the packet must be directed in order to eventually arrive at the destination device. A network device may be a computer or any other device as long as it is capable of performing the required network tasks.

A network router accepts packets from a plurality of input ports, determines which output port or ports each packet is destined for and forwards the packets to that or those output port or ports. Some network routers, such as disclosed in the U.S. Pat. No. 6,370,145, which is incorporated herein by reference in its entirety, split the incoming packets into smaller units called “flits” (flow control digits) and sequence each flit separately through the router's internal fabric to the output port where the flits are recombined into packets before being output from the router. A flit may be identical with a packet.

Parallel computers use several computation devices or processors (such as microprocessors) to work in coordination on a single or multiple tasks. To achieve this, these processors exchange data. One means of such exchange is sending packets of data from one processor to another, thus substantially implementing network functionality. In other words, a parallel computer generates data packets and then forwards them to one or more destination ports across its interconnection network.

A crossbar is a simple fabric architecture found in many communication systems. It is illustrated in FIG. 1. A crossbar is capable of connecting any input port 100 to any output port 8 at a given time by connecting or closing an appropriate cross-point 9. Scheduling the crossbar requires a policy that maps data transport requests to a series of crossbar configurations and the appropriate grants to move the data at the right time. If multiple input ports 100 want to move data to a same output port 8 simultaneously, all but one input port 100 must wait. In addition to fabric overspeed, i.e., speed in excess of throughput requirements, input queuing on inputs 100 is often included to deal with bursty traffic and scheduling inefficiencies and to provide look-ahead/bypassing.

Though crossbars are simple, there is a limit to their scalability. Distributed or multi-stage fabrics, comprised of multiple crossbars wired together in a certain topology such as a mesh, torus, butterfly, fat tree, or Clos, are scalable and are known to those skilled in the pertinent art. The distributed or multi-stage fabrics may be described as a network of interconnected nodes, each node transferring flits or packets of data to one of several neighboring nodes via a link connecting the nodes. In such fabrics, a flit or a packet instead of traveling directly from an input port 100 to an output port 8 (as is the case for the fabric shown in FIG. 1) may travel from an input port to a node, from this node, to another node, and so forth until reaching an output port. These fabric nodes may have internal memory and processing capabilities.

Some distributed fabrics, such as a simple butterfly, only have a single path between a given input port and a given output port. Most such fabrics, however, are augmented to provide redundancy, leading to multiple paths. Other fabrics, such as tori or fat trees, inherently have multiple paths between a given input port and a given output port.

Some systems, such as that presented in U.S. Pat. No. 6,370,145 rely on source routing in which the full path from a source node to a destination node is selected at the source node and included in a header of the first flit of a packet. In a more recent development of that system, queues corresponding to different virtual paths from the source to a destination are established at the source node. Queues for packets to be forwarded are selected in a round-robin fashion such that packets forwarded to the destination node are sprayed across the multiple paths to distribute traffic through the fabric. In order to detect and correct for packets lost within the fabric, an epoch bit associated with each packet was periodically toggled starting with the packet sent from queue 0. The same epoch bit was used on all subsequent packets until the next periodic toggling.

### SUMMARY OF THE INVENTION

The present invention provides several improvements to packet routing and processing which may be used individually or together.

In accordance with one aspect of the invention, data packets are delivered from a source node to a destination node connected by several paths. Packet queues at the source node are each associated with at least one path. A packet queue is selected based on local information indicative of the state of paths, and packets are moved into the selected packet queue. The packets are moved from the selected packet queue through one of the at least one path associated with the associated packet queue.

Selection of a packet queue may depend on whether there is another packet queue containing less data, whether the amount of data in the queue is over a limit amount for the queue and/or whether the amount of data in non-emergency packet queues is over a limit amount. The selection may also depend on priority assigned to the queue and on time stamps attached to packets in the queue.

In accordance with another aspect of the invention, data packets arriving at a node on a network are resequenced. Packet queues are provided at the node, and a queue identifier is attached to each data packet. The packets are placed in the queues and, after extracting a first packet from its queue, a second packet is extracted from a queue identified by the queue identifier attached to the first packet. Each output queue may be associated with a path through the network to the node from a source node.

In accordance with another aspect of the invention, an epoch identifier is attached to a data packet before it arrives at a node. Loss of a packet can be determined based on an unexpected change in the epoch identifier. The epoch identifier may be one bit, and it may be determined by a destination queue at the node.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of crossbar fabric architecture.

FIG. 2 illustrates functioning of a distributed fabric.

FIG. 3 shows a dimension-ordered routing path between a source and a destination.

FIG. 4 illustrates functioning of a distributed fabric with one path per dimension permutation.

FIG. 5 shows adaptive routing making a poor global decision.

FIG. 6 shows a queue structure with one queue per path.

FIGS. 7A-7D show a time sequence of states in one embodiment of this invention.

FIGS. 8A-8D show a time sequence of states in another embodiment of this invention.

FIGS. 9A-9I show a time sequence of states in a third embodiment of this invention.

FIGS. 10A-10C show a time sequence of states in a fourth embodiment of this invention.

FIGS. 11A-11G show a time sequence of states in a fourth embodiment of this invention.

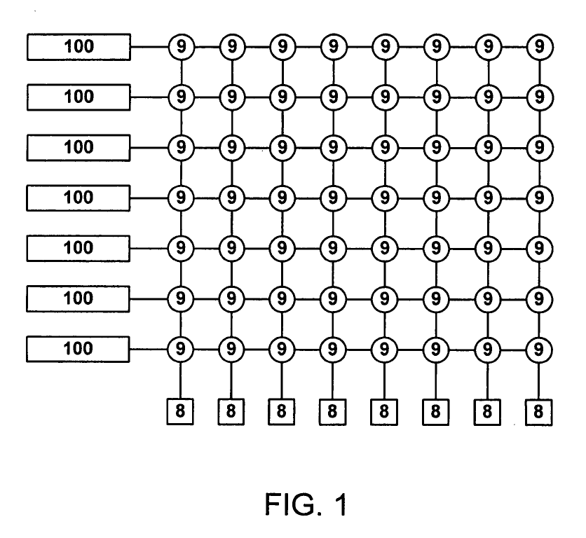

### DETAILED DESCRIPTION OF THE INVENTION

A description of preferred embodiments of the invention follows.

A network of computers, such as the Internet, fits the description of a distributed fabric. Therefore, all considerations and description below including embodiments of this invention are valid and functional where the fabric under consideration is a computer network. Hereinafter all data transfer units, including packets and flits, are called packets.

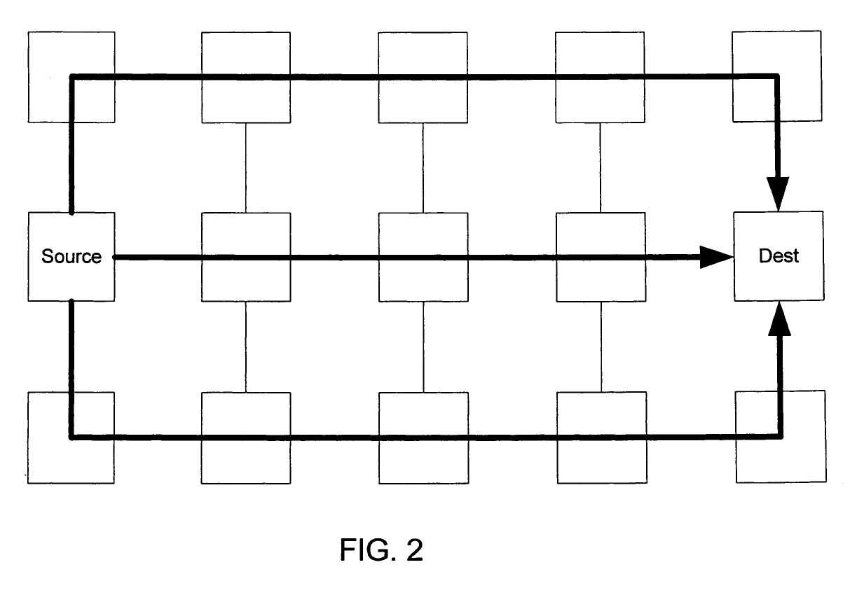

In a distributed fabric, usually there is more than one path between a source and a destination node. For example, three possible paths between the source and destination are shown in FIG. 2. In this example, none of the links are used by more than one path. In general, however, it is possible that different paths share links.

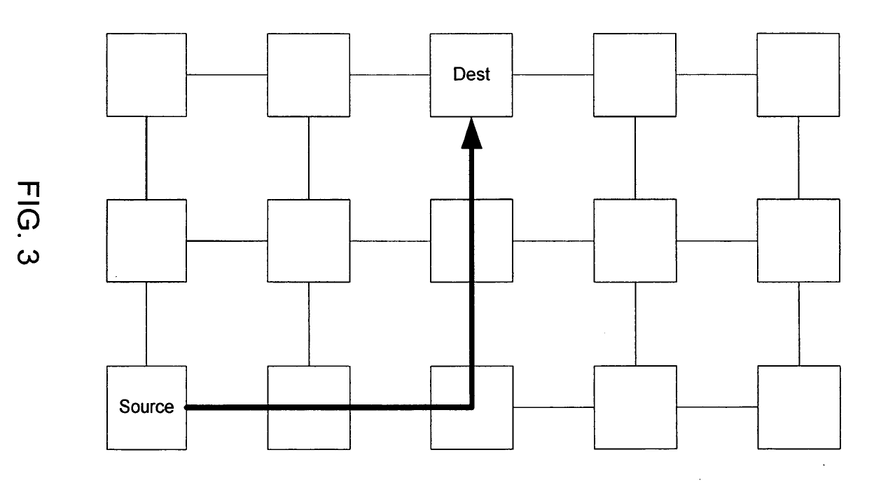

There are many methods to compute the set of possible paths between a given source and a given destination. Many are dependent on the fabric topology. One method for a mesh/torus network is dimension-ordered routing. In this routing scheme, the minimum number of link hops in each dimension is computed. A single path is generated that routes the packet in a chosen dimension order, in other words, a permutation of the directions is chosen (such as X, then Y, then Z) and all packets are routed strictly in that order of dimensions. FIG. 3 shows a dimension-ordered routing path between a source and a destination. Note that the X dimension is first routed to completion then the Y dimension is routed to completion.

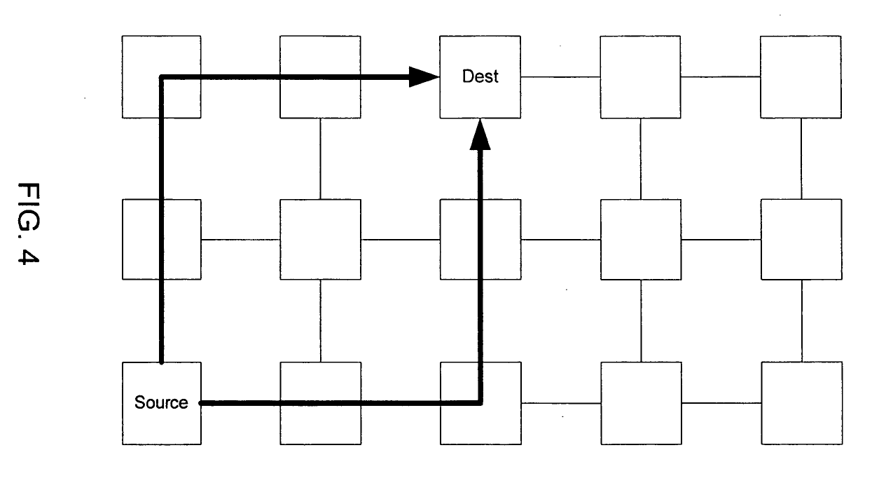

The dimension-ordered routing has a limitation of having only a single path for a source/destination pair, always taking the same directions in the same order. This increases the probability of congestion, i.e. of a situation when a link is incapable of handling the volume of packet traffic directed to it. One way to improve dimension-ordered routing is to generate a path per permutation of the dimensions. For example, provide a path routing the X dimension first, then the Y dimension and another path that routes the Y dimension first, then the X dimension. This modification generates one path per permutation as shown in FIG. 4.

Multiple paths per source/destination pair are useful for many reasons including load balancing to reduce the probability of congested or slowed links and fault tolerance to minimize the impact of a down link.

Given multiple paths between each pair of input port and output port, a particular path must be selected when sending each packet. The path may be determined at the source (source-routing), as the packet is traversing links in the fabric (adaptive-routing), or using a combination of the two methods.

In a source-routing system, paths must be determined at the start and whenever there is a fabric topology change. Paths may also be determined more frequently to incorporate information such as packet traffic load on links or may even be determined anew for each packet. In a source-routing system, the source decides based on its local information which path each packet is expected to traverse and associates a path identifier with the packet before it is sent into the fabric. One way to specify a path identifier is to specify all link hops on the path. Each intermediate node in the fabric uses the path identifier to determine the next link for the packet to traverse. The intermediate node does not alter the path selected by the source.

There are many possible path selection schemes. Two simple methods are to select the paths randomly or to select the paths in sequential order. Both methods are simple to implement, but do not maintain packet order within the fabric.

Another method is to use specific bits of a packet to determine which path to select, for example, by hashing these bits. For example, each IP packet contains a header that specifies the source IP address that the packet is coming from and a destination IP address that the packet is going to. One method of selecting a path within a router is to hash the source IP address and destination IP address to form a path selector. One advantage of this method is that packets with the same source and destination IP addresses follow the same path which, in most fabrics, keeps the packets in order. This method allows packets that are of different flows, a flow being a set of packets with the same source and destination IP addresses, to travel along different paths. This method usually spreads flows evenly across the available paths, generally balancing the loads on the paths.

Another method to select paths is to assign a weight to each path and to select paths based on these weights. A path that has less bandwidth capability for some reason may be weighted less and thus selected less frequently than a path that has higher bandwidth capability. When packets are variable-sized, selection of paths based on weights may account for packet size to get the best path load balancing. Provided a sufficient number of paths and sufficient resolution in weighting, such a scheme may optimally spread load across the fabric (B. Towles, W. J. Dally, S. P. Boyd, “Throughput-centric routing algorithm design,” ACM Symposium on Parallel Algorithms and Architectures (SPAA), pp. 200-209, San Diego, Calif., June, 2003). This scheme, however, does not maintain packet ordering through the fabric.

A packet in a source-routing system follows the path fully specified by the source. Even if there is congestion somewhere on the path; the packet must use the specified path.

An adaptive-routing system, on the other hand, allows a packet to make dynamic decisions on a link-by-link or node-by-node basis to avoid congestions within the fabric. In such systems, when a packet arrives at a node, that node determines which of the acceptable links are less loaded and directs the packet towards that link.

Several adaptive-routing algorithms exist. Minimum adaptive routing, for example, restricts adaptation to select only productive next link hops, i.e., the link hops that get the packet closer to its destination. Congestion information is used to select, on a hop-by-hop basis, which of the productive links to take.

Fully adaptive routing allows packets to traverse unproductive hops moving the packet further away from the destination. Productive next hops are generally favored to reduce the number of wasted hops. Livelock-avoidance mechanisms are used to ensure that packets eventually reach their final destination.

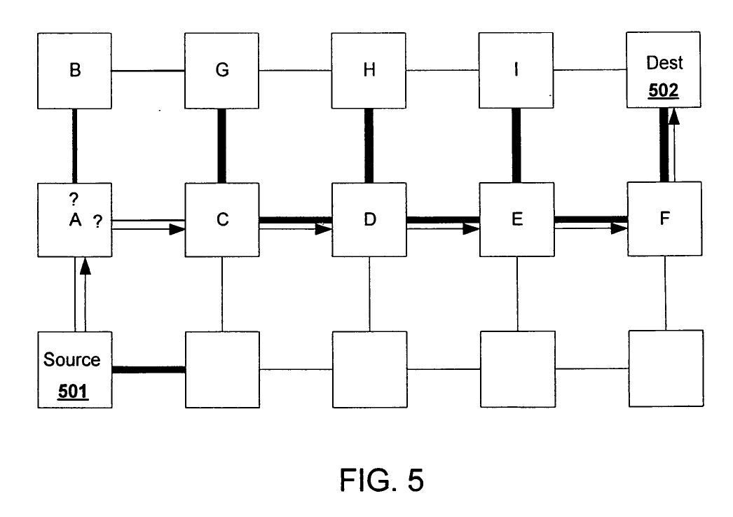

Adaptive routing may perform significantly better than source routing when there is congestion in the fabric. Because adaptive routing only makes local decisions, however, it may make poor global decisions. An example of adaptive routing making a poor global decision is shown in FIG. 5, where the slower links are shown as thicker lines. In this example, the source 501 sends a packet to the node A. The node A makes a local decision to forward the packet to the node C because there is no congestion on that link. Instead, it should have forwarded the packet to the node B because there is no congestion from B to the destination 502. Continuing from C, the adaptive algorithm moves traffic in the X dimension, going through D, E and F, instead of routing from C to G, encountering more congestion on the first link to G, but then no congestion from G to the destination 502.

Thus, though adaptive routing may perform well, there are situations where it does not. In addition, adaptive routing requires a certain amount of computation capabilities in the intermediate nodes to be able to route around congested links.

Regardless of the routing mechanism used, a congested fabric must either drop packets in intermediate nodes or apply back-pressure, i.e. somehow make the source node store or queue some packets to avoid sending additional packets to the congestion point until the congestion is diminished.

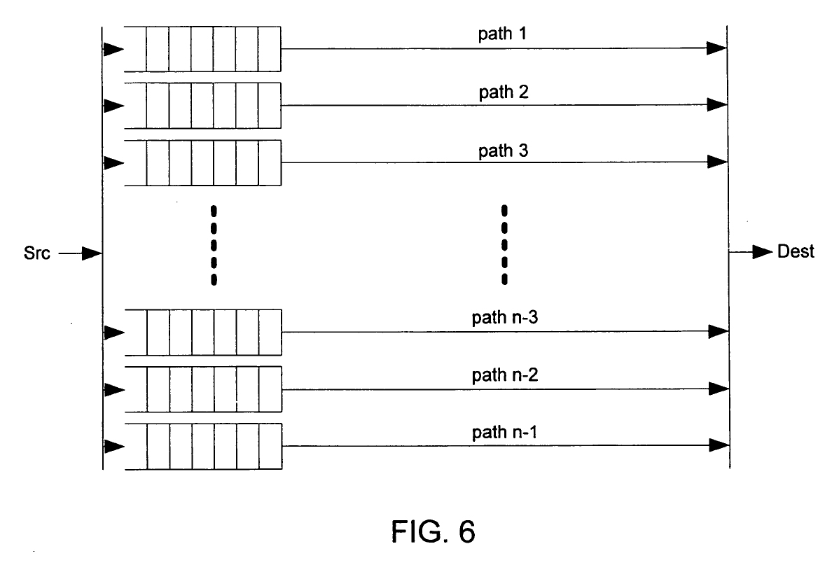

There are many possible queuing strategies: per destination/priority, per path, per partial path such as destination/first hop, etc. One queue may be dedicated to each path (as shown in FIG. 6), one queue may feed several paths, or multiple queues may feed a single path. Once a path is selected for a packet, the packet is placed into the appropriate queue.

The choice of queuing strategy generally depends on how packet traffic is spread across the multiple paths. For example, if the path is selected right before a packet is inserted into the fabric, queuing per destination/priority is a good queuing strategy if a full packet may either always be inserted (this is unlikely to be true) or may always be bypassed by a packet behind it. Otherwise, a queue may be blocked by a packet destined for a congested path.

Another queuing strategy is to have one queue per destination/path/priority. Assuming a lossless fabric with back-pressure, such a queuing strategy ensures that congestion on one path does not affect other paths.

In some embodiments of this invention, source-routed paths are selected based on feedback from the fabric. This method is referred to as “adaptive source routing”. Such feedback may come in a variety of ways, but one way is to look at the depths of queues as it reflects the fabric's condition. These embodiments use this information on a packet-by-packet or other basis to determine which source-routed path through the fabric a packet takes. Doing so permits the path selection to adapt to the dynamic load within the entire fabric rather than only on a link-by-link basis as in adaptive routing. This method improves source-routing systems to the point that they may potentially match or even outperform prior art adaptive routing systems while avoiding the per-link precessing overhead of prior art adaptive routing.

For example, in embodiments implemented within a source-routed system with one queue per path, the path selection may be made dependent on the queue depth by always selecting the shallowest queue. This ensures that packet traffic is evenly balanced across all paths, even when some paths are congested, because congested paths accept packets slower than non-congested paths.

These embodiments may use the following algorithm. A size count is kept for each queue indicating the current size of the queue (in bytes, oct-bytes (64 bits), or some other fixed size quantum or in number of packets). For each packet arriving at the source node, the system determines the minimum queue depth for the queues feeding all possible paths to the packet destination, places the packet into the minimum depth queue, and adds the size of the packet to the size count. As the packets are removed from the queues and sent via the fabric to their destinations, the corresponding queue size counts are decreased by the size of the sent packets.

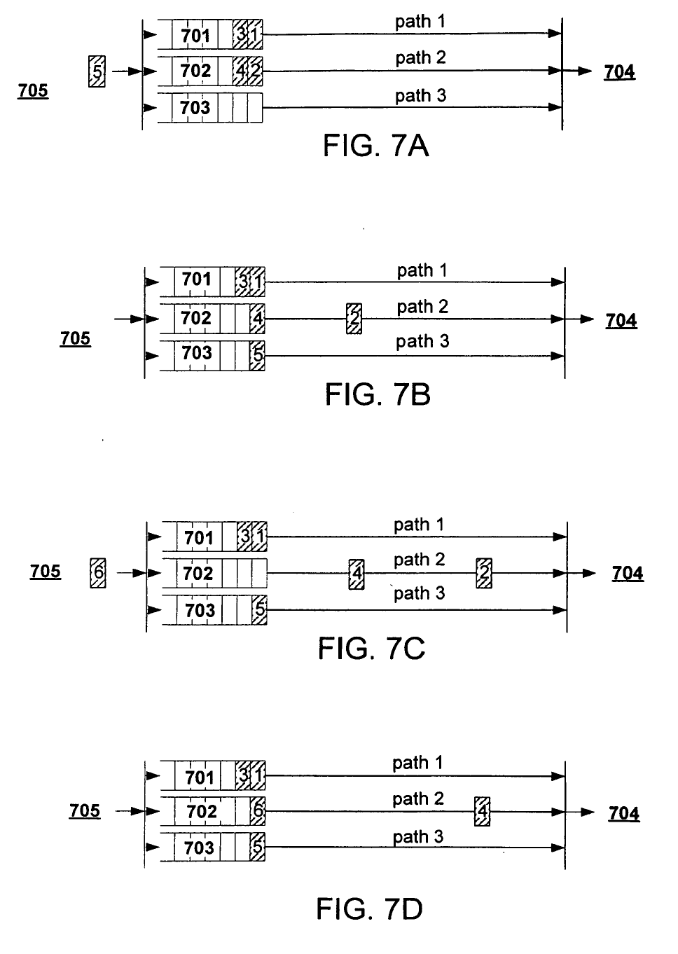

The time sequence of states of one such embodiment is shown in FIGS. 7A-7D. In this embodiment there are three paths between a source node 705 and a destination node 704 and each path has its queue 701-703. FIG. 7A shows the moment when at the source node 705 there are two packets in the queue 701 used by the path 1 and two packets in the queue 702 by the path 2. As shown in FIG. 7B, the packet 5 after arrival at the source node 705 is placed into the queue 703 used by the path 3, because it has the minimum depth queue. After the queue 702 is drained and becomes the minimum depth queue, as shown in FIG. 7C, the next packet arriving at the source node 705, packet 6, is placed into the queue 702, as shown in FIG. 7D. Even though no packets are being sent to path 1, paths 2 and 3 are still being supplied with new packets to be forwarded. Note that packets will not arrive at the destination node 704 in the order in which they have arrived at the source node 705.

Other embodiments of this invention may select paths in an absolute priority order among the paths whose queue depth is below a configurable (per queue) threshold. If no queue depth is below its configurable threshold, the choice is being made in round-robin fashion among a subset of queues. This scheme incorporates path preference into path selection. These embodiments allow assigning some paths as emergency paths to be used when there is significant congestion on the preferred paths.

These embodiments may use the following algorithm. A depth count is kept for each queue indicating the current depth of the queue (in some fixed-sized quantum such as bytes). A round-robin pointer to a current emergency queue is kept as well. Every queue has a settable threshold. For each packet arriving at the source node, the system checks in the order of priority the queues of the paths to the packet destination, looking for the first queue whose depth is lower or equal to its threshold. If such a queue is found, the packet is placed into that queue and the depth count of that queue is incremented by the size of the packet. Otherwise the system goes to the emergency queue indicated by round-robin pointer to choose an emergency queue number, places the packet in that emergency queue, sets the round-robin pointer to its next value, and increments the queue's depth count by the size of the packet. As the packets are removed from the queues and sent via the fabric to their destinations the corresponding queue size counts are decreased by the size of the sent packets.

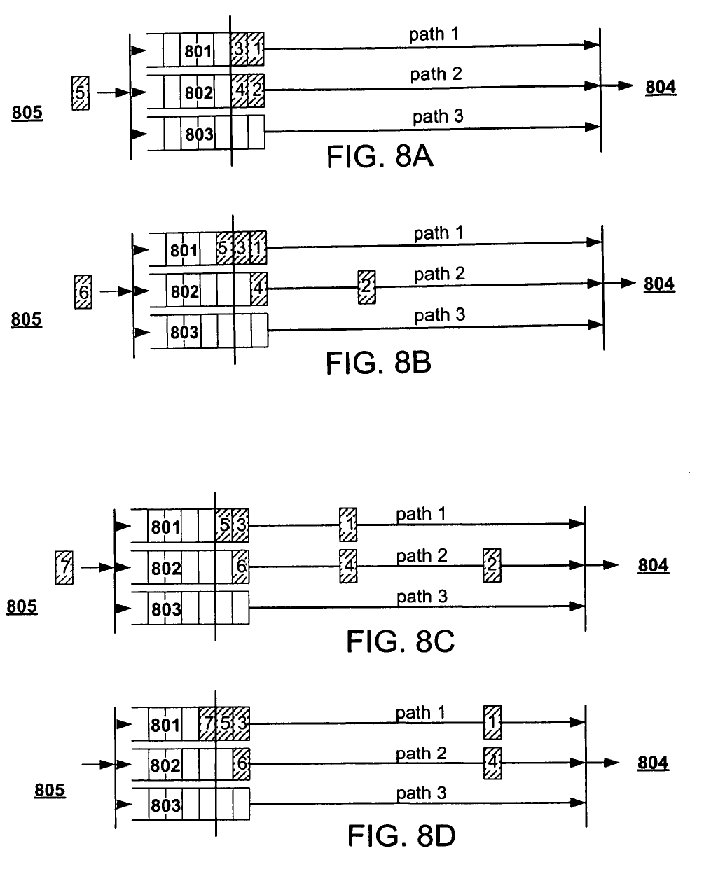

The time sequence of states of one such embodiment is shown in FIGS. 8A-8D. In this embodiment there are three paths between a source node 805 and a destination node 804 and each path has its queue 801-803. The paths' order of priorities is path 1, path 2, and path 3. All thresholds are set at 2 packets. When the packet 5 arrives to the source node 805, the depth of the queue 801 is equal to the threshold of 2, as shown in FIG. 8A. Thus, packet 5 is placed into the queue 801, as shown in FIG. 8B. When the packet 6 arrives, the queue 801 is above the threshold, but the queue 802 is below the threshold. Thus, the packet 6 is placed into the queue 802, as shown in FIG. 8C. When the packet 7 arrives, the queue 801 is again at the threshold and thus the packet 7 is placed into the queue 801, as shown in FIG. 8D. Notice that even though the queue 803 is empty throughout the example, packets are never enqueued in it because either the queue 801 or the queue 802 is never above the threshold.

Other embodiments of this invention may use local information in a variety of ways. They may use queue depth information to determine which queue to enqueue a packet using other algorithms or they may attach time stamps to packets and look at which queues move faster than others making queue selections on this basis.

Embodiments of this invention may also use the adaptive source routing for part of the path and adaptive routing for the rest of the path. For example, an embodiment may first adaptively source route to a selected region of the fabric, then adaptively route within that region of the fabric. This scheme may combine the benefits of both methods by making a global decision to choose the best path to get close to the destination and then using adaptive routing to get around local bottlenecks. Other combinations (such as adaptive routing through a part of the route, followed by adaptive source routing through another part, and finishing with adaptive routing) are useful as well.

Other embodiments of this invention may allow multiple paths to share a single queue.

Many routing schemes, including the adaptive source routing, deliver packets to the destination node out of the order in which the packets arrive to the source node. For some applications, such as certain parallel computer applications, reordered packets are acceptable. In other applications, such as Internet routing, packets must be delivered in order.

For applications that require ordering, resequencing must be provided when reordering routing schemes are used, for example, as described above. Resequencing requires sequencing information, either implicit or explicit, to be passed between the source and destination.

An implicit scheme uses a defined order of paths when selecting paths. For example, using a sequential order of paths on the source node and always starting at path 0 allows the destination node to reconstruct the packet order after the source node and the destination node have been synchronized once. Another implicit scheme is to send at least a certain number of bytes across a path before advancing to the next one. This scheme approximately balances the load across all the paths.

An explicit scheme involves attaching an unambiguous sequence number to each packet. “Unambiguous” in this case means that there is no possibility that the same sequence number is attached to multiple packets simultaneously at the source node. These sequence numbers may be used to reconstruct the original packet order at the destination node. For example, the Internet TCP protocol uses 32 bit long sequence numbers, a number space large enough to be effectively unambiguous.

The implicit schemes do not require extra information to be attached to each packet. They depend on a fixed protocol between the source node and the destination node, making them unable to adapt to changing fabric conditions such as congested paths.

An explicit ordering scheme may be used to rapidly adapt to dynamically changing fabric conditions. A large sequence number, however, is not always practical for reasons including the overhead of the large sequence number and the complexity of resequencing a large number space.

Some embodiments of this invention use sequence numbers only large enough to distinguish a path. Given a fixed number of paths, an individual path may be identified with log₂(number of paths) bits. Rather than using a full sequence number that defines the total order of the packets at the source node, these embodiments attach a path pointer to each packet that identifies or points to the path from which the next source packet will come. Assuming a fixed starting path agreed to by the source node and the destination node, always specifying the next path is unambiguous.

In other embodiments of this invention the number of bits in the pointer is reduced because the pointer specifies one of a subset of all the paths from the source node to the destination node. In these embodiments, each path has a static or dynamic set of next paths, the next path being the path chosen for a packet following the packet sent through the first path. For example, an embodiment may restrict path 1 to only be able to have paths 2 and 3 as the next path, requiring only a single bit to specify the next path.

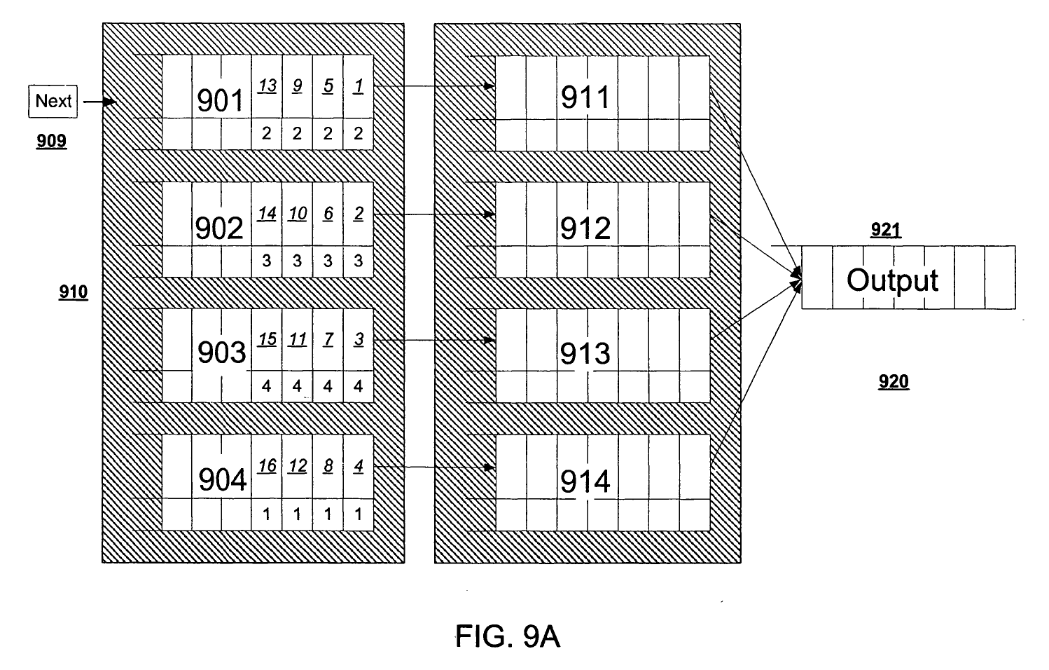

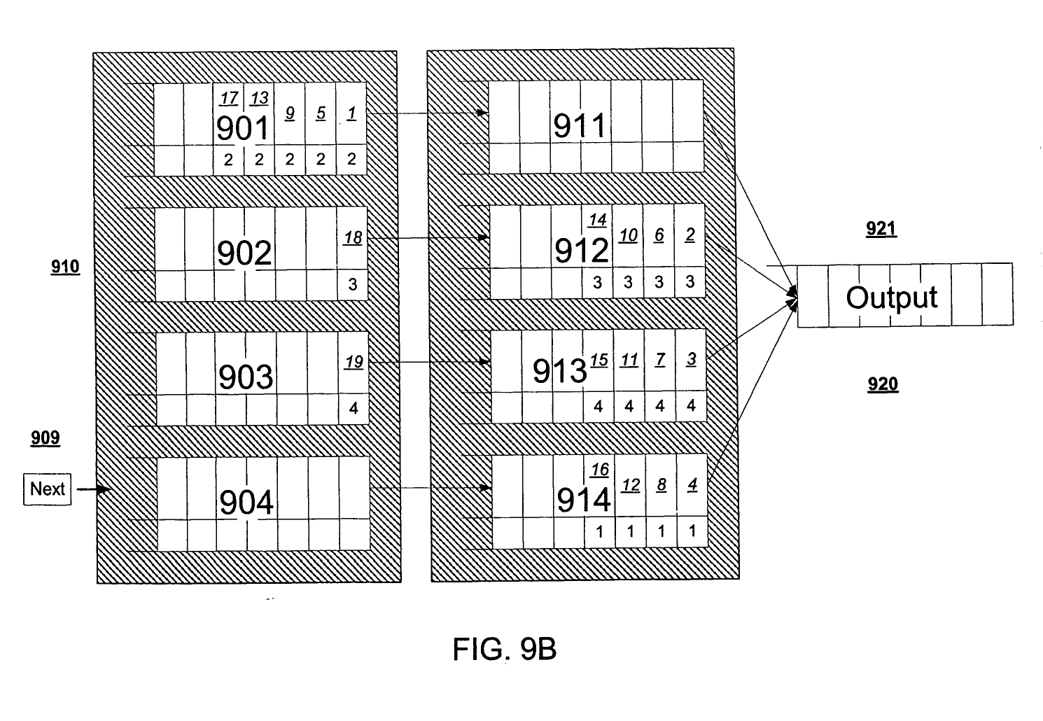

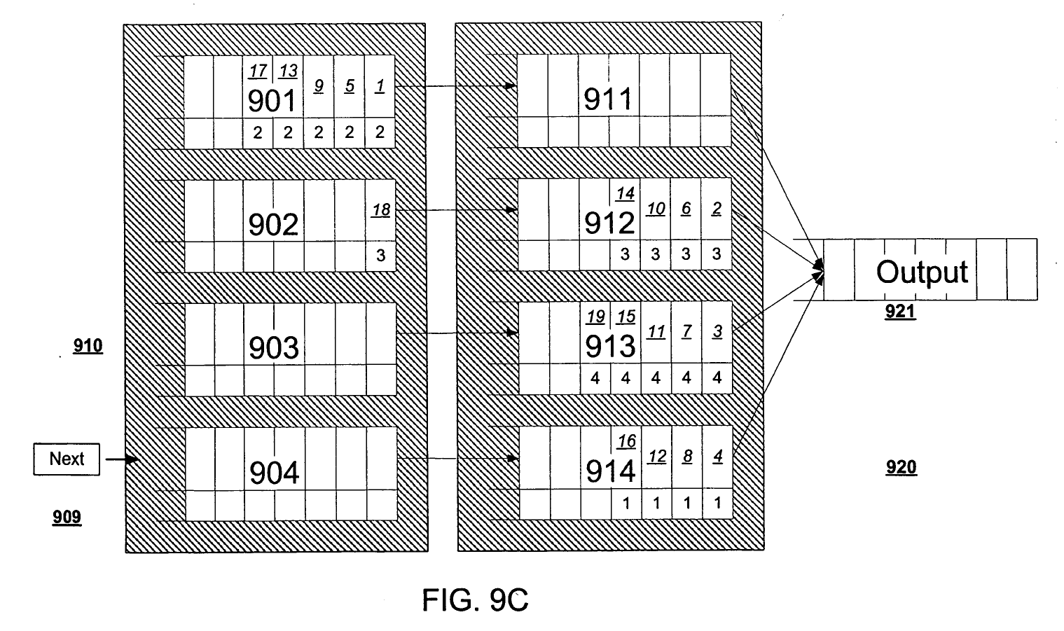

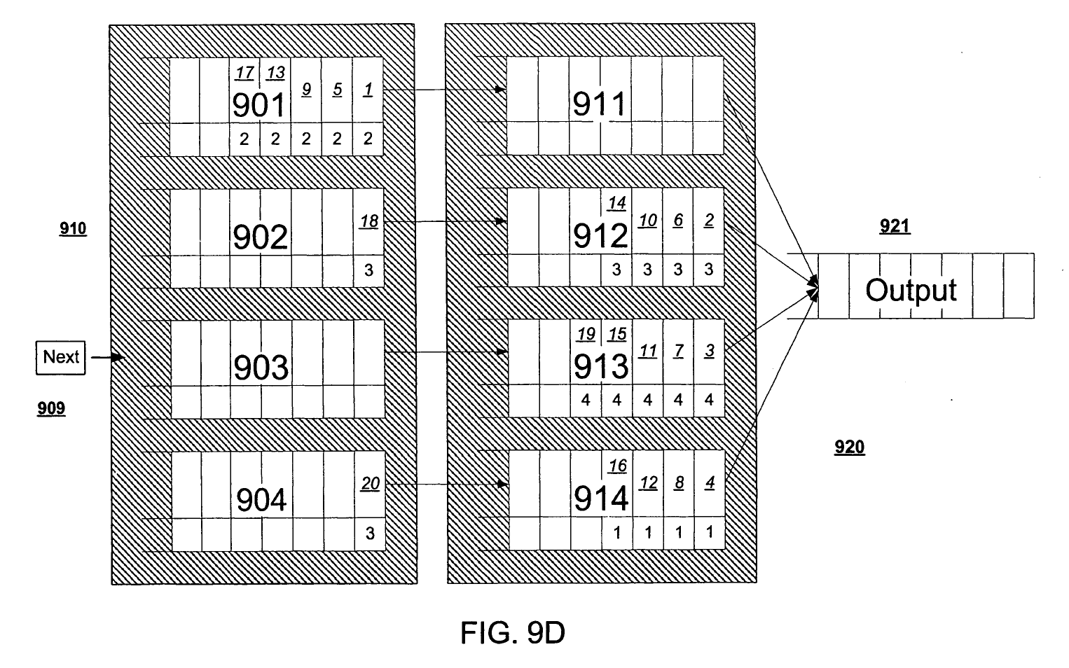

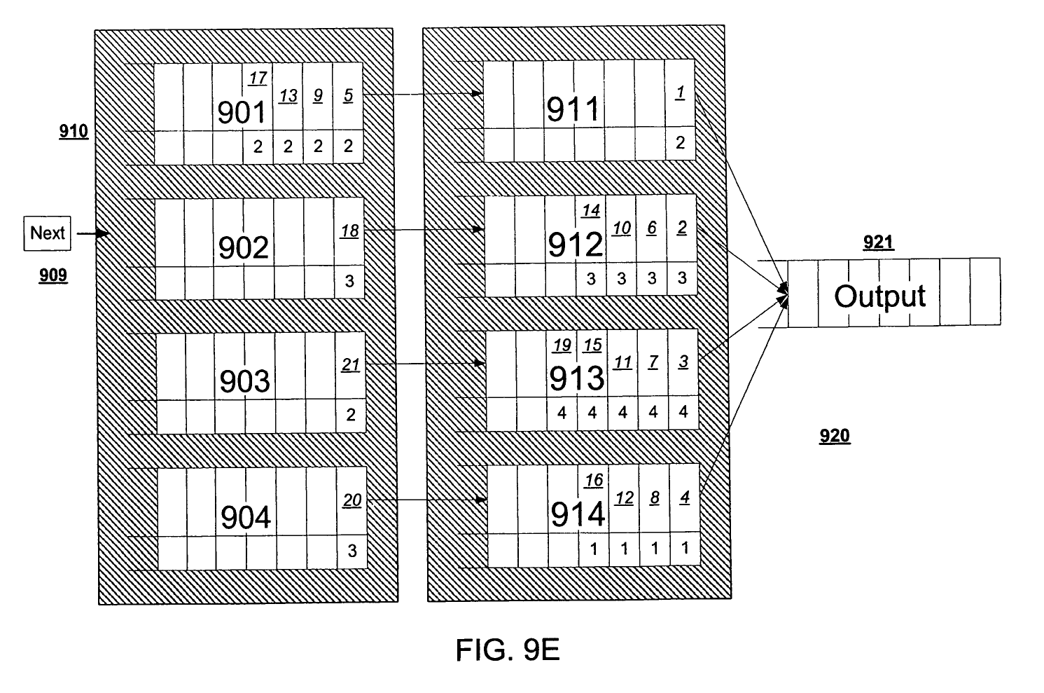

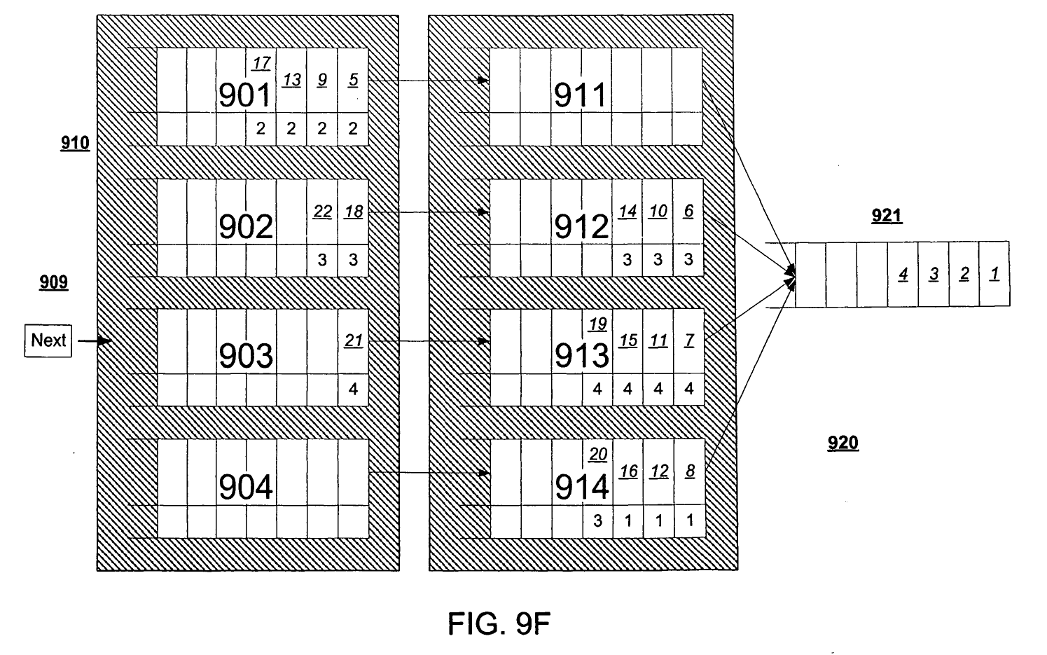

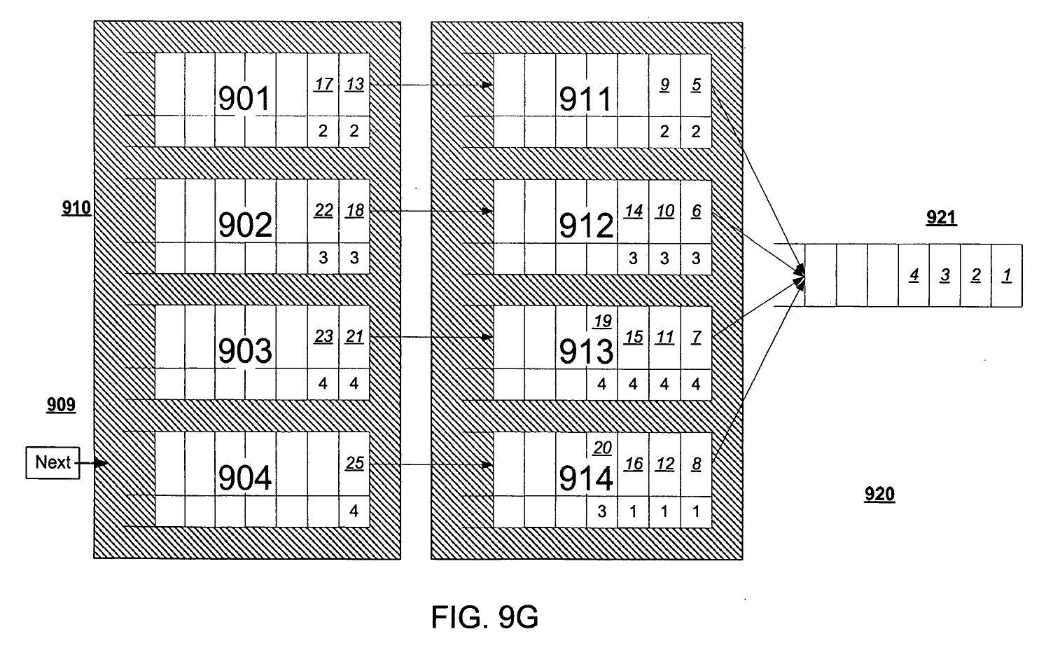

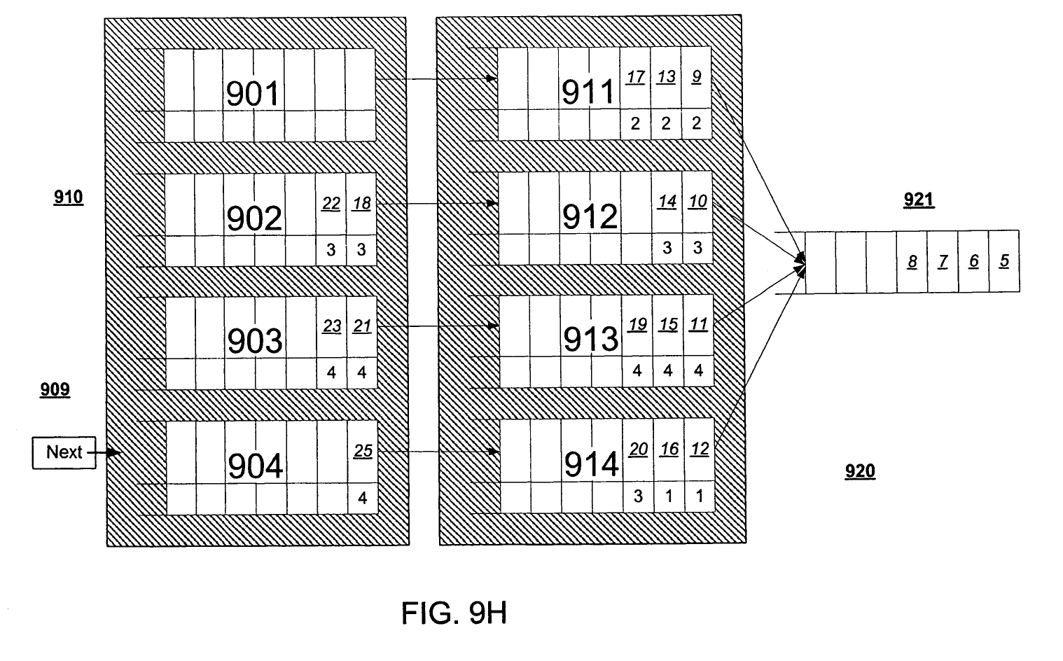

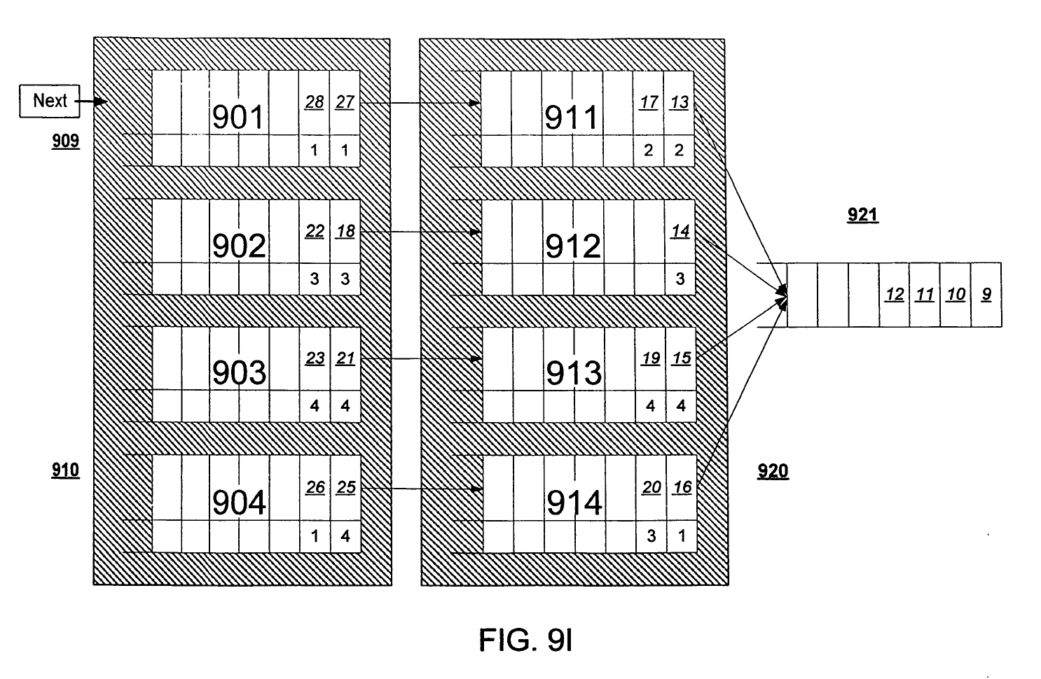

FIGS. 9A-9I show a time sequence of states of an embodiment of this invention using minimum queue length as the path selection strategy for adaptive source routing and a next path indicator as a method for resequencing the packets at the destination node 920. In each queue, packet numbers are indicated over corresponding next-path pointers.

At the moment shown in FIG. 9A, at the source node 910 each of the source queues 901-904 contains 4 packets. All the packets in queue 901 point to queue 902 as the source of the next packet, all of the packets in queue 902 point to queue 903 as the source of the next packet and so on. The next pointer 909, i.e. the pointer indicating the queue in which the next packet is to be placed, is pointing to queue 901.

FIG. 9B shows the moment after the queues 902, 903, and 904 have been drained of the original packets. No packets have been drained from the queue 901. 3 more packets have arrived. The first, packet 17, is placed into the queue 901 since the next pointer was pointing to queue 901, even though it's possible that the queue 1 was the fullest queue at the time packet 17 arrives. Packet 18 is placed into queue 902 and packet 19 is placed into queue 903. The next pointer 909 is pointing at the queue 904 since it is currently empty.

FIG. 9C shows the moment after the queue 903 has been drained. Notice that no packets have been sent to the output port 921 because the destination node 920 is still waiting for a packet on the queue 911.

FIG. 9D shows the moment after a packet has arrived to the source node 910 and has been placed into the queue 904. The next pointer 909 is pointing at queue 903, since it is empty.

FIG. 9E shows the moment after a packet has been forwarded from the queue 901 into the buffer 911. At this point, packets starting from the queue 911 may be forwarded to the output port 921.

FIG. 9F shows the moment after all of the packets that could be forwarded to the output have been. The packets 1, 2, 3, and 4 have been sent to the output 921. The output 921 is waiting for the queue 911 to get packet 5 from queue 901. As new packets arrive, they are being placed in the queues 902, 903, and 904 which are moving more rapidly than the queue 901. This dynamic targeting of queues with more space and dynamic balancing of the load across the paths is characteristic of adaptive source routing.

FIG. 9G shows the moment after two packets from the queue 901 arrive to the queue 911. Now, 8 packets may be moved to the output port 921. Packets continue to arrive at the source node 910 and are distributed to the least loaded queues 901-904.

FIG. 9H shows the moment after the queue 901 has been completely drained. Many packets may be moved from the queues 911-914 to the output port 921.

FIG. 9I shows the moment after some packets have been placed into queue 901, since it was the least filled queue at the source node. Packets are moving more regularly to the destination node 920, because bandwidths have effectively been balanced across the available paths.

Some fabrics may drop packets in some situations, for example in the presence of severe back-pressure. When a path pointer-based resequencing scheme is used in such fabrics, packets at the destination node get out of order and stay out of order when one or more packets are dropped within the fabric.

To avoid such situations, some embodiments of this invention use a resynchronization mechanism that periodically resynchronizes the source node packet sequence to the destination node packet sequence. In these embodiments, the source node and the destination node periodically agree on which packet is the next packet. Once this re-agreement is performed, packets stay in order until the next time a packet is dropped within the fabric (hopefully a rare occurrence).

To achieve this result these embodiment may include an extra bit per packet that indicates a particular time space, or epoch. The epoch bit toggles at a slow rate at the source node; thus it is expected that multiple successive packets carry the same epoch bit value. If both epochs are seen interleaved, as described below, at least one packet has been dropped and cleanup must occur, essentially clearing out the packets of the old epoch before proceeding with packets from the new epoch.

The epoch transitions always occur on a predetermined path. For example, one policy is that the transition always occurs on path 1. Thus, if an inconsistency is found, where epochs are interleaved, packets tagged with the old epoch are cleared out, then the new epoch started on the predetermined path. These embodiments get packets in order within one epoch time once packet dropping within the fabric has stopped.

Other embodiments of this invention may use epoch indicators longer than one bit.

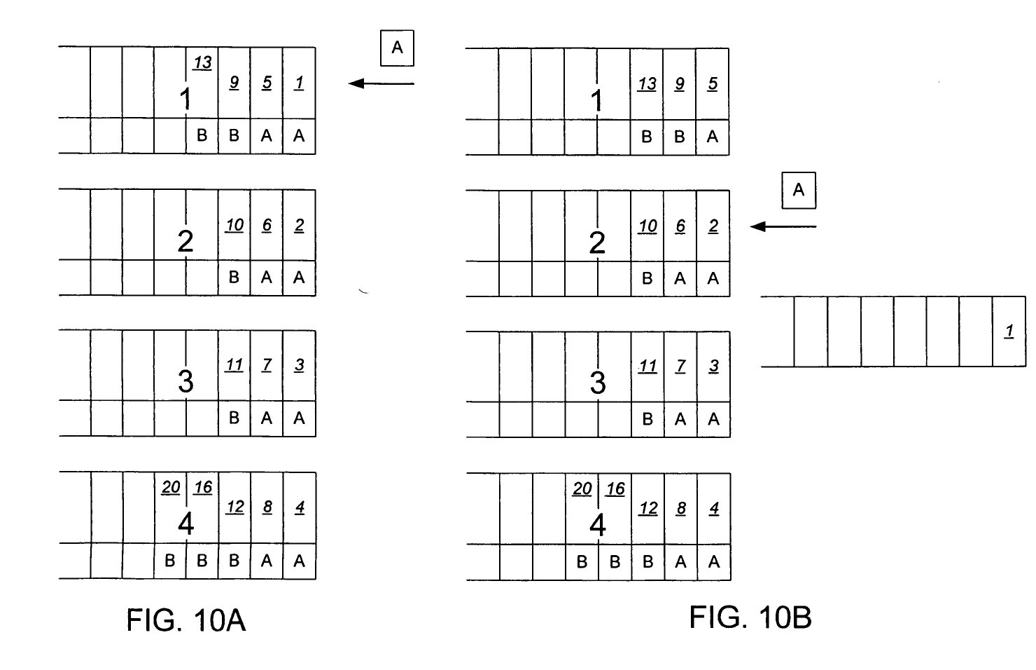

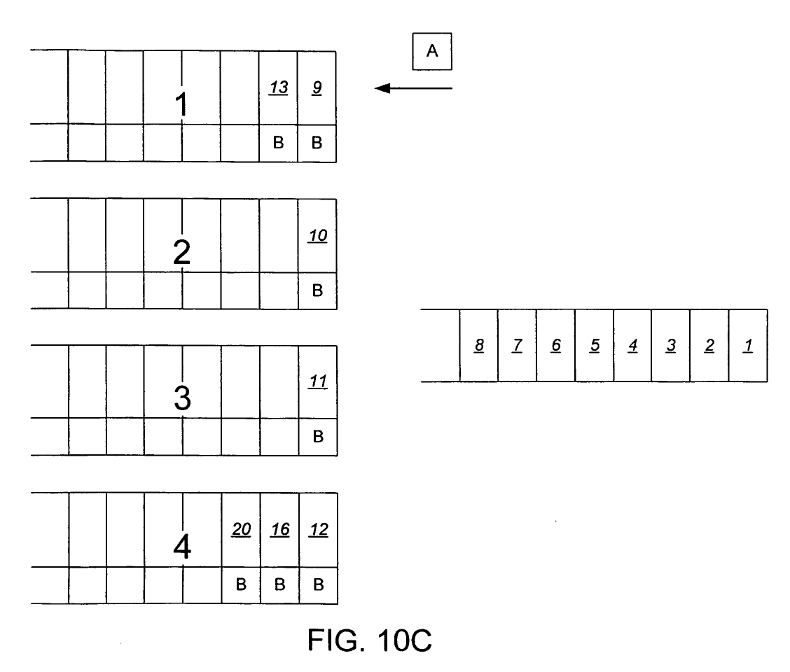

FIGS. 10A-10C show the use of a one bit epoch indicator (A or B) in one embodiment of this invention where the epoch switch occurs on the path associated with queue 1. FIG. 10A shows fetching a packet off the destination queue 1. The epoch bit is checked and is determined to be A. The epoch bit of the next packet taken off the queues 2, 3, and 4 are also supposed to be A unless a packet has been lost in the fabric. FIG. 10B shows that packet 2 fetched off the queue 2 satisfies this test. This checking continues with the queues 3 and 4. Then the packet 5 is taken off the queue 1, its epoch bit is still A, and the checking continues with packets 6, 7, and 8. When the packet 9 is taken off the queue 1, its epoch bit is determined to be B, as shown in FIG. 10C, and the checking continues in the same manner.

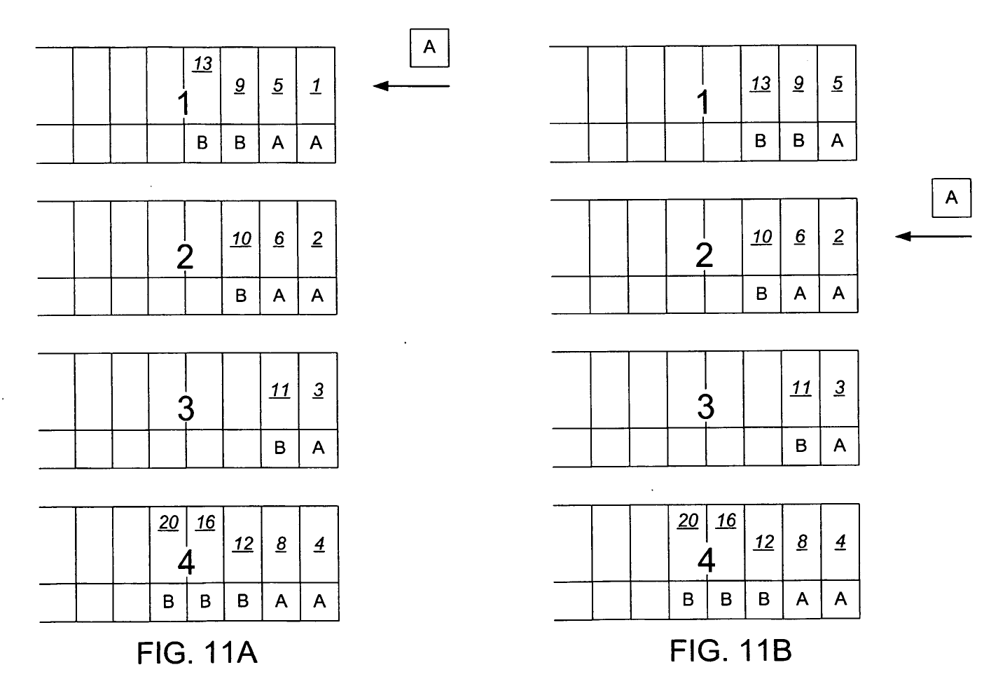

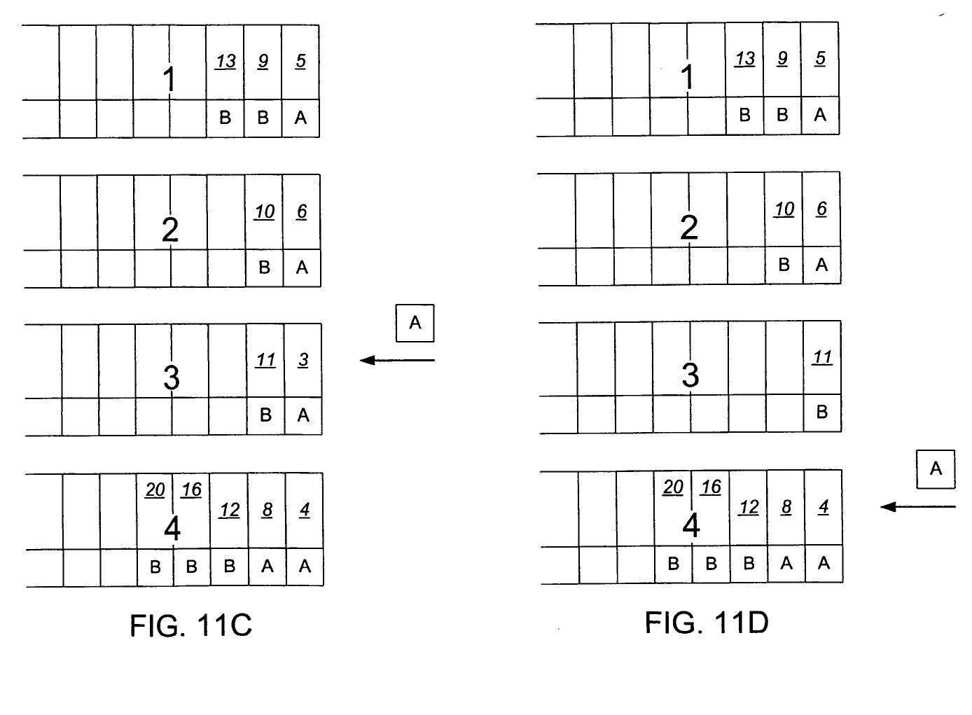

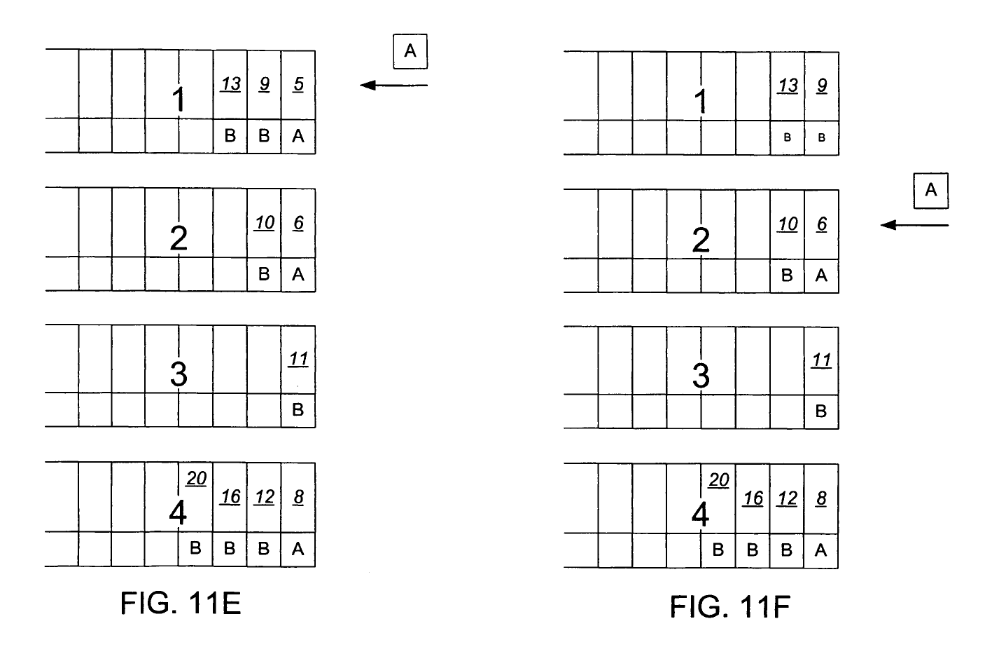

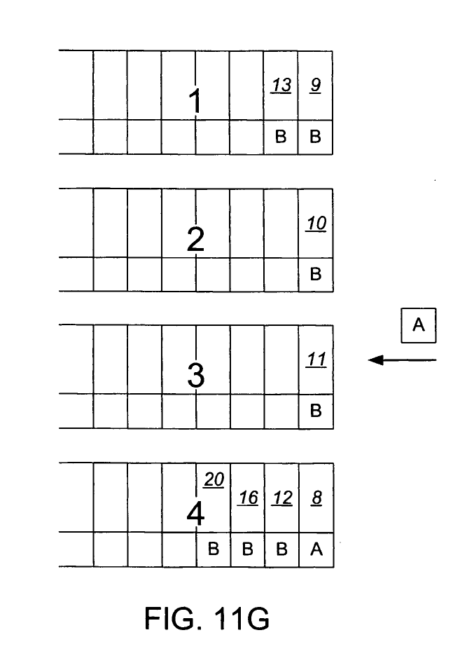

FIGS. 11A-G show how the embodiment shown in FIGS. 10A-C handles situations when a packet, in this case the packet 7, is lost. FIGS. 11A-D show that the checking is proceeding as expected after the epoch bit is set as A as shown in FIG. 11A. The epoch bit is set as A again after the packet 5 is taken off the queue 1, as shown in FIG. 11E. The checking proceeds as expected on FIG. 11F. On FIG. 11G, however, the system detects the epoch bit B (carried by packet 11) different from the expected epoch bit A. After detecting this error, this embodiment removes packet 8 and disregards it, as it has epoch bit A and is therefore out of sequence. The next packet is fetched from the queue 1 where the epoch bit is B, and the normal checking is resumed.

The time during which the epoch indicator is constant should be long enough to prevent aliasing.

As discussed in the background, a prior product supported round-robin packet spraying with epoch bits. Round-robin spraying selects the next queue in a strict round-robin fashion, regardless of the queue state. Such a scheme is easy to implement but does not adapt to dynamic queue/path conditions. For example, even if one queue is slow and has filled up, the round-robin scheme will still enqueue packets into that queue when that queue is next. Since all queues need to be serviced in a round-robin fashion, faster queues must wait for slower queues. Thus, all queues run at the rate of the slowest queue in the group, potentially affecting performance.

In this round-robin spraying scheme, an epoch bit was used to detect and correct for packets lost within the fabric. The epoch bit was only toggled on a fixed queue (queue 0 in the implementation) to improve the accuracy of lost packet detection. If the queue in which epoch bit could be toggled first was not fixed, certain error cases, such as the case where a single packet from queue 0 was lost, would not be detected.

The new epoch scheme presented here, designed to work with adaptive spraying, does not need to transition the epoch bit on a set queue, but instead could transition on any queue. By transitioning the epoch state every set number of packets, the same accuracy is achieved without the spraying scheme having to artificially force the next queue to be a deterministic queue.

While this invention has been particularly shown and described with references to preferred embodiments thereof, it will be understood by those skilled in the art that various changes in form and details may be made therein without departing from the scope of the invention encompassed by the appended claims. For example, the system may keep information at a finer granularity than the packet queue. For example, a packet queue may handle four paths. Information for each of the paths may be kept, rather than or in addition to information for the packet queue. Alternatively, the system could apply packets from multiple queues onto one path.

1. A method of delivering a data packet from a source node to a destination node connected by several paths, comprising the steps of:
providing packet queues at the source node, each queue associated with at least one path;
selecting a packet queue based on local information indicative of the state of paths;
moving the packet into the selected packet queue; and
moving the packet from the selected packet queue through one of the at least one path associated with the selected packet queue.

2. The method of claim 1 wherein the selecting of a packet queue depends on whether there is another packet queue containing less data.

3. The method of claim 2 wherein the selecting of a packet queue depends on time stamps attached to packets in the queue.

4. The method of claim 1 wherein the selecting of a packet queue depends on whether the amount of data in the queue is over a limit amount for the queue.

5. The method of claim 4 wherein the selecting of a packet queue depends on time stamps attached to packets in the queue.

6. The method of claim 1 wherein the selecting of a packet queue depends on the priority assigned to the queue and the depths of all the queues.

7. The method of claim 1 wherein the selecting of an emergency packet queue depends on whether the amount of data in non-emergency packet queues is over a limit amount.

8. The method of claim 1 wherein the selecting of a packet queue depends on time stamps attached to packets in the queue.

9. The method of claim 1 further comprising
providing destination packet queues at the destination node;
attaching to each data packet a destination packet queue identifier;
placing the packets into the destination packet queues; and
after extracting a first packet from its destination packet queue, extracting a second packet from the destination packet queue identified by the destination packet queue identifier attached to the first packet.

10. The method of claim 1 further comprising
providing destination packet queues at the destination node;
before a data packet arrives at the destination node, attaching an epoch identifier to the data packet; and
determining that a packet has been lost based on an unexpected change in the epoch identifier.

11. The method of claim 1 wherein data packets are source routed from the source node.

12. A method of re-sequencing data packets arriving at a node on a network comprising the steps of:
providing packet queues at the node;
attaching to each data packet a queue identifier;
placing the packets into the queues;
after extracting a first packet from its queue, extracting a second packet from the queue identified by the queue identifier attached to the first packet.

13. The method of claim 12 further comprising associating each output queue with a path through the network to the node from a source node.

14. The method of claim 11 further comprising
before a data packet arrives at the node, attaching an epoch identifier to the data packet; and
determining that a packet has been lost based on an unexpected change in the epoch identifier.
